(19) United States
(12) Patent Application Publication
(10) Pub. No.: US 2005/0138150 A1
(43) Pub. Date: Jun. 23, 2005

(54) System and method for graphically presenting change and configuration management information

(75) Inventors: Sapan Bhasker, Westford, MA (US); Susan Cohan, Needham, MA (US)

Correspondence Address: Robert R. Lech, Esq.;Calfee, Halter & Griswold LLP, Suite 1100, 21 East State Street, Columbus, OH, 43215-4243, US

(73) Assignee: Computer Associates Think, Inc.

(21) Appl. No.: 10/888,273

(22) Filed: Jul. 9, 2004

Related U.S. Application Data
(60) Provisional application No. 60/487,060, filed on Jul. 11, 2003.

(51) Int. Cl. G06F 15/177

(52) U.S. Cl. 709/220

(57) ABSTRACT

Methods, systems, apparatus and computer-readable media are disclosed for presenting change and configuration management (“CCM”) information. A first exemplary method is disclosed that includes transmitting to a CCM server, a request for enterprise-wide CCM information. The method also includes receiving from the CCM server, CCM viewing instructions and CCM data, based on a CCM application and a CCM database. The method further includes transmitting to a remote server, at least one request for platform-specific CCM information. Each request for platform-specific CCM information corresponds to a platform. The method further includes receiving a set of platform-specific CCM information corresponding to each request. Each set of platform-specific CCM information is based on a CCM application and a CCM database associated with the platform. The method still further includes displaying the CCM information and each set of platform-specific CCM information in an integrated display. Other methods, apparatus, systems and computer readable media are disclosed for presenting CCM information.

### CROSS REFERENCE TO RELATED APPLICATIONS

This application claims priority to and incorporates by reference the entirety of U.S. provisional application entitled “System and Method for Graphically Presenting Change and Configuration Management Information,” Ser. No. 60/487,060, filed Jul. 11, 2003.

### TECHNICAL FIELD

The described systems and methods are generally related to information processing environments in which software changes and configurations are managed. More specifically, the described systems and methods are related to graphically presenting change and configuration management information.

### BACKGROUND

Today's software development teams build large, distributed application systems. Teams work from heterogeneous platforms at remote locations and make simultaneous changes to a multitude of interrelated software modules and system documentation. One common way to effectively track this complex, enterprise-wide development activity is with a comprehensive, repository-based, web-enabled change and configuration management (“CCM”) application. Two such exemplary CCM applications are known as “AllFusion Endevor Change Manager” on a mainframe platform and “AllFusion Harvest Change Manager” on Unix and Windows platforms, each of which is developed, manufactured and marketed by Computer Associates (“CA”), the assignee of the present application.

These and other prior art change and configuration management applications are designed to provide change management information for software modules for a specific operating system or platform, such as Windows, UNIX or mainframe platform, for example. Consequently, an enterprise supporting multiple platforms is presently unable to automatically obtain a comprehensive or integrated view of change and configuration management information from multiple CCM products on different platforms. Presently, users typically have to login in to multiple different change and configuration management applications on different platforms to gather CCM information from the CCM applications on those platforms and manually combine the CCM information from different platforms using one or more software tools, such as a word processor, spreadsheet or other graphical visualization tools.

Consequently, there is a need for methods and systems that address the shortcomings of prior art change and configuration management applications and provide an integrated graphical visualization of change and configuration management data from multiple CCM applications on different platforms. A need exists for methods and systems to enable CCM administrators and senior managers to clearly understand enterprise-wide CCM information and easily manage them from a single point of control through a web-based application. More specifically, there is a need to enable visualization of cross-platform CCM information in the form of bar graphs, pie charts and other reports, from CCM applications on both distributed and mainframe platforms and make the graphical visualization of CCM information available through a web-based application.

### SUMMARY

The following presents a simplified summary of methods, apparatus, systems, and computer readable media associated with graphically presenting change and configuration management information in accordance with the present application. This summary is not an extensive overview and is not intended to identify key or critical elements of the methods, apparatus, systems, and/or media or to delineate the scope of the methods, apparatus, systems, and media. It conceptually identifies the methods, apparatus, systems, and media in a simplified form as a prelude to the more detailed description that is presented later.

In accordance with one aspect of the present application, an exemplary method is disclosed for presenting CCM information in a graphical format. The method includes transmitting a request for CCM information to a CCM server. The method also includes receiving, from the server or a database associated with the server, CCM information based on a CCM application. The method further includes transmitting to a remote server at least one request for platform-specific CCM information. Each request for platform-specific CCM information corresponds to a platform. The method still further includes receiving a set of platform-specific CCM information corresponding to each request. Each set of platform-specific CCM information is based on a CCM application and optionally a related database associated with the corresponding CCM application. In addition the method includes displaying the CCM information and each set of platform-specific CCM information in an integrated display.

In accordance with a second aspect of the present application, an exemplary system is disclosed for presenting CCM information. The system includes a web browser client, and a graphical viewer embedded in the web browser client. The graphical viewer is operative to graphically display integrated CCM information. The system also includes a server in communication with the web browser client. In the case where the CCM application is on a distributed platform like UNIX or Windows, for example, the server is in communication with a CCM database and a CCM application, and the server is operative to receive a request for display of graphical CCM information and respond to the request by returning the web page containing the graphical viewer. The graphical viewer can query the CCM database and display the CCM information in a graphical format. In the case where the CCM application is on a mainframe platform, the server is in communication with the server of the mainframe CCM application using an application specific Application Program Interface (“API”). The CCM information is stored on the mainframe typically as Virtual Storage Access Method (“VSAM”) files. The mainframe CCM application returns the mainframe CCM information to the server. The viewer can interpret the received CCM information and display it in a graphical format.

In accordance with a third aspect of the present application, an exemplary apparatus is disclosed for presenting CCM information. The apparatus includes a processor and a memory in communication with the processor. The memory stores a program to control the operation of the processor. The processor is operative with the program in the memory to transmit to a server, a request for CCM information, and receive from the server, CCM information based on a CCM application and a related database.

The processor is also operative with the program in the memory to transmit to a remote server, at least one request for platform-specific CCM information. Each request for platform-specific CCM information corresponds to a platform. The processor is further operative with the program in the memory to receive a set of platform-specific CCM information corresponding to each request. Each set of platform-specific CCM information is based on a CCM application and a related database associated with the platform. The processor is still further operative with the program in the memory to display the CCM information and each set of platform-specific CCM information in an integrated display.

In accordance with a fourth aspect of the present application, an exemplary computer-readable storage medium is disclosed. The medium is encoded with processing instructions for presenting CCM information.

Certain illustrative aspects of the methods, apparatus, systems and computer-readable media are described herein in connection with the following description and the annexed drawings. These aspects are indicative, however, of but a few of the various ways in which the principles of the methods, apparatus, systems, and media may be employed and thus the examples are intended to include such aspects and equivalents. Other advantages and novel features may become apparent from the following detailed description when considered in conjunction with the drawings.

### BRIEF DESCRIPTION OF THE DRAWINGS

For a more complete understanding of the present methods and systems, reference is now made to the following description taken in conjunction with the accompanying drawings in which like reference numbers indicate like features and wherein:

FIG. 1 is a block diagram illustrating an example enterprise information processing environment, in accordance with the systems and methods described in the present application;

FIG. 2 is a block diagram illustrating a more detailed view of certain components of the example enterprise information processing environment of FIG. 1; and

FIG. 3 is an example methodology for presenting CCM information in an integrated display.

### DETAILED DESCRIPTION

Example methods and systems are now described with reference to the drawings, where like reference numerals are used to refer to like elements throughout. In the following description, for purposes of explanation, numerous specific details are set forth in order to facilitate thoroughly understanding the methods and systems. It may be evident, however, that the methods and systems can be practiced without these specific details. In other instances, well-known structures and devices are shown in block diagram form in order to simplify the description.

The present application relates to and incorporates by reference the entirety of two U.S. provisional patent applications entitled “System and Method for Visualization of Metadata,” Ser. No. 60/487,061, and U.S. provisional patent application entitled “System and Method for Displaying Impact Analysis Data”, Ser. No. 60/487,063, each filed Jul. 11, 2003. The present application also relates to and incorporates by reference the entirety of two concurrently filed U.S. non-provisional patent applications entitled “System and Method for Visualization of Mainframe Change Management Metadata” and “System and Method for Displaying Impact Analysis Data,” each incorporated by reference in its entirety.

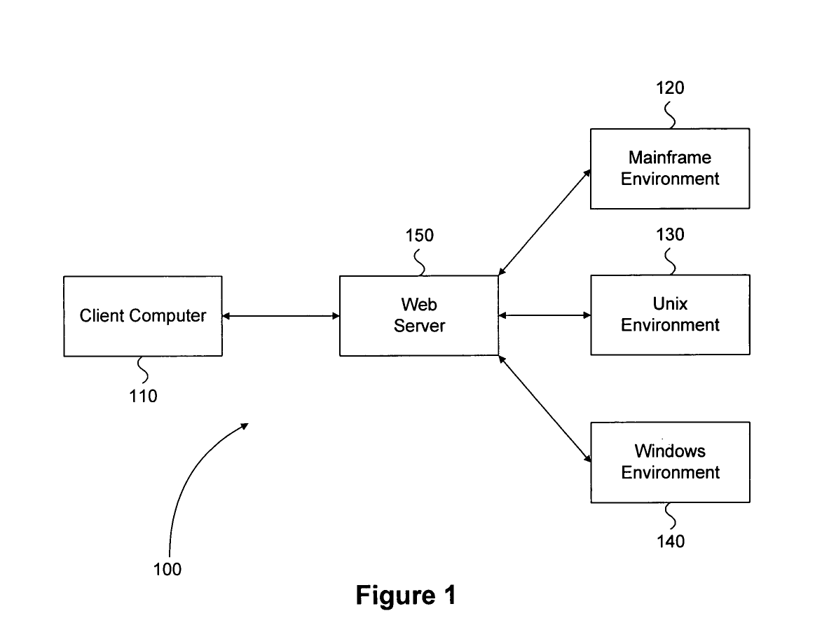

Referring to FIG. 1, a schematic block diagram illustrates an example enterprise information processing environment 100, and associated data flow within the example environment. The example enterprise environment 100 includes a client computer 110 that is in communication with a Web server computer 150. The server application within the web server computer 150 is in communication with mainframe environment 120. The client computer 110 is also in communication with a database client on the web server computer 150. The database client enables communication between the graphical viewer on the client computer and the databases containing the CCM information on certain platform-specific environments, such as a UNIX environment 130 and a Windows environment 140, for example. According to the example enterprise environment 100, a user employs computer 110, to request enterprise-wide, integrated CCM information using a single query. An example would be the user requesting an enterprise package status overview display. An enterprise CCM package in this example includes more than one CCM package where each CCM package could belong to a CCM application on the mainframe or on a distributed platform. Processing of the query is distributed among several components of the enterprise 100 to provide a graphical display of enterprise-wide CCM information at a single point of control, namely computer 110.

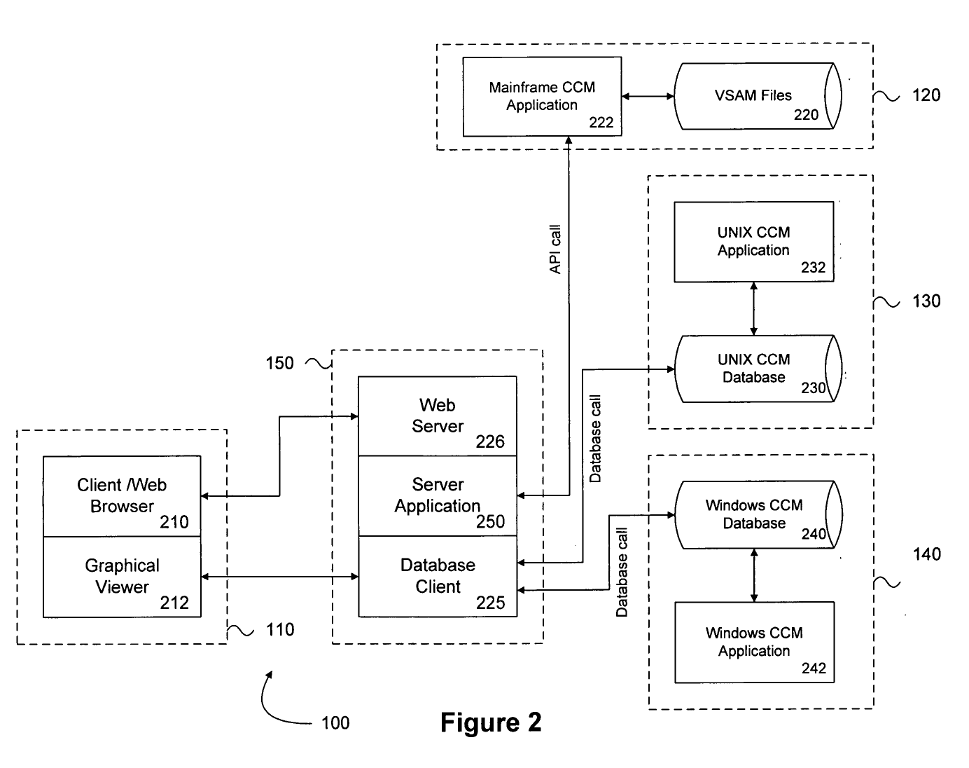

Referring now to FIG. 2, a schematic block diagram illustrates in more detail the example enterprise environment 100 illustrated in FIG. 1. Specifically, client computer 110 includes a web browser application 210 and a graphical viewer 212. In the illustrated example embodiment, the graphical viewer 212 is an application that is embedded or integrated within the web browser 210.

Web browser 210 of computer 110 communicates with server application 250 of server computer 150. Specifically, web browser 210 transmits an HTTP query for enterprise-wide CCM information to the web server 226. The query is processed by server application 250 which provides an integrated, centralized point of control for change management activities for CCM products on mainframe 120 and distributed platforms 130 and 140.

As shown, web browser 210 requests the integrated CCM information from server application 250, and server application 250 services the request, by returning the requested web page containing the graphical CCM information to the web browser 210. In case the requested CCM information is located on the CCM application on the mainframe 120, the Server Application 250 makes an API (“Application Program Interface”) call to the Mainframe CCM application 222. The mainframe CCM information typically resides on the mainframe in the form of VSAM files 220 and is returned to the server computer 150 in comma separated value (“CSV”) format. The Graphical Viewer 212 can access the mainframe CCM information in CSV format on the web server 226 and display it in a graphical format in the web browser 210 on the client computer 110.

In addition to obtaining CCM information from mainframe 120, through the server computer 150, computer 110 may also communicate indirectly with other distributed platforms like UNIX and Windows, via the database client 225. Through the database client 225, computer 110 may access the CCM information associated with distributed platforms, such as UNIX platform 130 and Windows platform 140, for example. Specifically, in accordance with the web pages and instructions received from the server computer 150, graphical viewer 212 may request information from UNIX CCM database 230 and/or Windows CCM database 240. Such requests and corresponding responses are facilitated by database client 225. UNIX CCM database 230 and Windows CCM database 240 may be maintained by UNIX CCM application 232 and Windows CCM application 242, respectively. In this way, the graphical viewer 212 can indirectly access the CCM information from the databases associated with other platforms, such as CCM database 230 of UNIX platform 130 and CCM database 240 of Windows platform 140, for example.

In one example embodiment, web browser 210 is a conventional web browser, such as Microsoft Internet Explorer 6.0 or Netscape 7.1, for example, that supports plug-ins or other integrated applications. The embedded graphical viewer 212 includes the ability to collect and combine data from several data sources, including relational databases, multi-dimensional data sources, or flat files in CSV format, for example, and present the combined data in a single location. In one example embodiment, the graphical viewer 212 could be “Cleverpath Forest & Trees Runtime” application which is developed, manufactured and marketed by Computer Associates, the assignee of the present application. Cleverpath Forest & Trees can be installed as a runtime application, which can run within a web browser, and may be used to provide visualization of CCM information.

In the example embodiment, the server application 250 is a thin-client web-based application that uses JSP and Java technologies on the web server to generate dynamic HTML web pages, such as in the AllFusion CM Enterprise Workbench, a web-based application provided by Computer Associates, for example. A Forest & Trees developer application may be used to develop the Forest & Trees graphical view files that can display the integrated CCM information in Graphical Viewer 212 from both mainframe and distributed platforms. Such graphical view files may be integrated into JSP web pages that are stored in web server 226 as part of the AllFusion CM Enterprise Workbench product. A copy of the Forest & Trees runtime installation executable may be installed on the AllFusion CM Enterprise Workbench server and may be automatically downloaded and installed on the user's computer when the user loads a web page containing a Forest & Trees graphical view file for the first time. Subsequently, the downloaded Forest & Trees runtime application 212 is executed whenever the user loads a web page containing a link to a Forest & Trees graphical view file.

Server application 250 processes the query and provides a query to access platform-specific CCM applications, such as CA's AllFusion Endevor CCM application 222 on mainframe 120. The platform-specific CCM application 222 responds with a query result including CCM data relating to the software supported by the platform in CSV format. The server application 250 may combine the received platform-specific query results with other query results from other platform-specific CCM applications and provides the processed query result to client web browser 210 for presentation to the user. In one embodiment, the combined query results may be presented to the user via a web page that refers to a Forest & Trees graphical view file on the server 150.

In order to access the CCM information from the AllFusion Endevor CM on Mainframe 120, Java programs on the AllFusion CM Enterprise Workbench server 250 make a call to the Endevor API on the Mainframe and download the resulting CCM information from AllFusion Endevor CM 222 on the mainframe to the workstation. The Forest & Trees runtime application 212 in the web page on the user machine can then access the AllFusion Endevor CCM information in CSV format on the server and display it graphically.

In order to access the CCM information from the AllFusion Harvest CM on UNIX 230 and Windows 240, the Forest & Trees runtime application 212 in the web page on the user computer 110 can utilize a remote data service running on a web server 226, for example an IIS web server running Microsoft Remote Data Services. The Forest & Trees runtime application 212 makes a database call to the database client 225, for example an Oracle database client, to access the appropriate data base, such as AllFusion CM Harvest database 230 and/or AllFusion CM Harvest database 240. Databases 230 and 240 are maintained by CCM applications 232 and 242, respectively.

The combined information from the CCM products on Mainframe, Unix and Windows platforms can be presented to the user graphically in the form of bar graphs, pie charts and other reports.

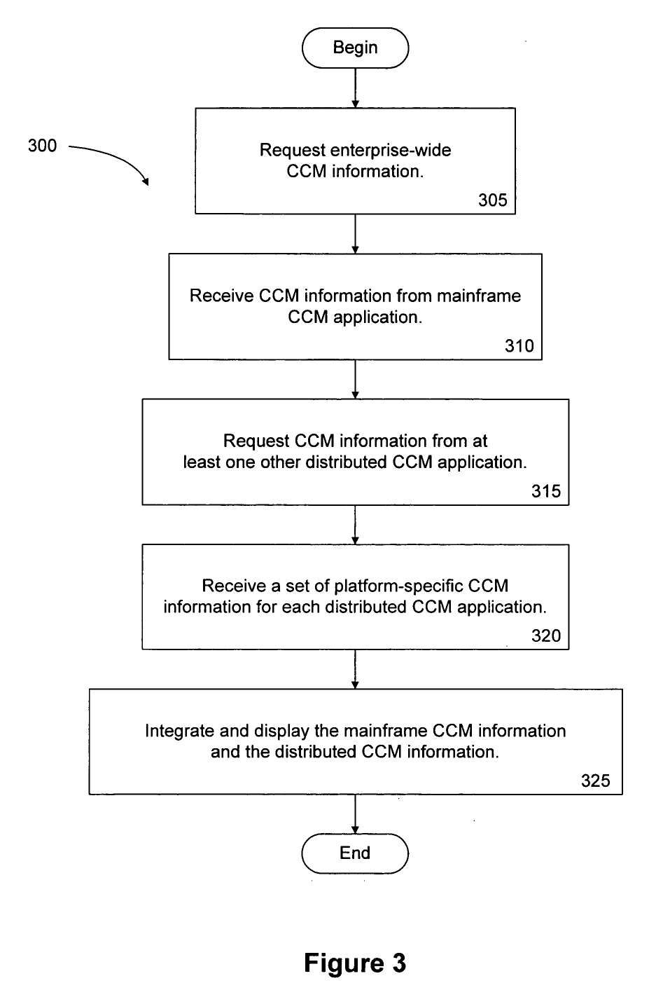

FIG. 3 is a flowchart illustrating an example method 300 for presenting integrated, enterprise-wide change and configuration management information. At block 305, a request for enterprise-wide CCM information is transmitted to a CCM application, such as mainframe CCM application 222, which is part of mainframe environment 120. A response to the request is received at block 310. The request includes CCM data describing the state of at least a portion of the enterprise with respect to change and configuration management. The CCM information provided to the server application is the result of an application specific API call to a CCM application such as mainframe CCM application 222 for example.

At block 315, at least one request for platform-specific CCM information is transmitted to a database client, such as database client 225. As shown by block 320, The database client responds to each request by querying an appropriate platform-specific CCM database, such as databases 230 and 240, for example, and providing the requested CCM information from the queried database. At block 325, the CCM information received at blocks 310 and 320 are integrated and displayed to provide an enterprise-wide view of change and configuration management information.

The combined information from the CCM products on Mainframe, Unix and Windows platforms can be integrated and presented to the user graphically in the form of bar graphs, pie charts and other reports. Additionally, context-sensitive drilldown functionality may be used to implement drilldown features in the product that allows the user to click on an overview summary report in the form of a pie chart or bar graph and then to drilldown to a more detailed report.

For example, a user may request an Enterprise Package Status Overview display. Such a display may contain a graphical representation of the current status of all enterprise-wide change management packages in a form of a pie chart. This gives an integrated picture of the current state of all enterprise-wide change management packages from a single location. The user can then select a particular area of the pie chart and view a detailed report about the enterprise change management packages in that particular state.

What has been described above includes several examples. It is, of course, not possible to describe every conceivable combination of components or methodologies for purposes of describing the systems, apparatus, methods, and computer readable media associated with graphically presenting change and configuration management information. However, one of ordinary skill in the art may recognize that further combinations and permutations are possible. Accordingly, this application is intended to embrace such alterations, modifications, and variations that fall within the scope of the appended claims. Furthermore, to the extent that the term “includes” is employed in the detailed description or the claims, such term is intended to be inclusive in a manner similar to the term “comprising” as that term is interpreted when employed as a transitional word in a claim.

1. A method for presenting change and configuration management (“CCM”) information, comprising:
transmitting to a CCM server, a request for enterprise-wide CCM information;
receiving from the CCM server, CCM data, the CCM data being based on a CCM application and a CCM database;
transmitting to a remote server, at least one request for platform-specific CCM information, each request for platform-specific CCM information corresponding to a platform;
receiving a set of platform-specific CCM information corresponding to each request, each set of platform-specific CCM information based on a CCM application and a CCM database associated with the platform; and
displaying the CCM information and each set of platform-specific CCM information in an integrated display.

2. The method of claim 1, further comprising receiving from the CCM server a viewer application for displaying the CCM information and each set of platform-specific CCM information in an integrated display.

3. The method of claim 1, wherein one request for platform-specific CCM information corresponds to a Unix platform.

4. The method of claim 1, wherein one request for platform-specific CCM information corresponds to a Windows platform.

5. The method of claim 1, wherein one request for platform-specific CCM information corresponds to an Apple platform.

6. The method of claim 1, wherein the CCM server, CCM application and CCM data reside on a mainframe computer.

7. The method of claim 1, wherein the CCM information from the mainframe CCM application is requested using an API (Application Program Interface) and the CCM information is received in the form of CSV (Comma Separated Value) information

8. The method of claim 1, wherein displaying the integrated display includes displaying at least one bar graph of the CCM information and each set of platform-specific CCM information.

9. The method of claim 1, wherein displaying the integrated display includes displaying at least one pie chart of the CCM information and each set of platform-specific CCM information.

10. A system for presenting change and configuration management (“CCM”) information, comprising:
a web browser client;
a graphical viewer in communication with the web browser client, the graphical viewer operative to display integrated CCM change information;
a server application in communication with the web browser client, the server application in communication with a CCM database and a CCM application, the server application operative to receive a request for CCM information, query the CCM application and access the CCM database to respond to the request for CCM information; and
a database client in communication with the graphical viewer, the database client further in communication with at least one platform-specific CCM database, the database client operative to receive a request for platform-specific CCM information, the database client further operative to query the platform-specific CCM database and respond to the request for platform-specific CCM information.

11. An apparatus for presenting change and configuration management (“CCM”) information, comprising:
a processor;
a memory connected to said processor storing a program to control the operation of said processor;
the processor operative with the program in the memory to:
transmit to a CCM server, a request for enterprise-wide CCM information;
receive from the CCM server, viewing instructions and CCM data, the CCM data being based on a CCM application and a CCM database;
transmit to a remote server, at least one request for platform-specific CCM information, each request for platform-specific CCM information corresponding to a platform;
receive a set of platform-specific CCM information corresponding to each request, each set of platform-specific CCM information based on a CCM application and a CCM database associated with the platform; and
display the CCM information and each set of platform-specific CCM information in an integrated display.

12. The apparatus of claim 11, wherein the processor is further operative with the program in the memory to receive from the CCM server a viewer application for displaying the CCM information and each set of platform-specific CCM information in an integrated display.

13. The apparatus of claim 11, wherein one request for platform-specific CCM information corresponds to a Unix platform.

14. The apparatus of claim 11, wherein one request for platform-specific CCM information corresponds to a Windows platform.

15. The apparatus of claim 11, wherein one request for platform-specific CCM information corresponds to an Apple platform.

16. The apparatus of claim 11, wherein the CCM server, CCM application and CCM data reside on a mainframe computer.

17. The apparatus of claim 11, wherein the processor is further operative with the program in the memory to request the CCM information from the mainframe CCM application using an API and receive the CCM information in the form of CSV information

18. The apparatus of claim 11, wherein displaying the integrated display includes displaying at least one bar graph of the CCM information and each set of platform-specific CCM information.

19. The apparatus of claim 11, wherein displaying the integrated display includes displaying at least one pie chart of the CCM information and each set of platform-specific CCM information.

20. A computer-readable storage medium encoded with processing instructions for presenting change and configuration management (“CCM”) information, the processing instructions for directing a computer to perform the steps of:
transmitting to a CCM server, a request for enterprise-wide CCM information;
receiving from the CCM server, viewing instructions and CCM data, the CCM data being based on a CCM application and a CCM database;
transmitting to a remote server, at least one request for platform-specific CCM information, each request for platform-specific CCM information corresponding to a platform;
receiving a set of platform-specific CCM information corresponding to each request, each set of platform-specific CCM information based on a CCM application and a CCM database associated with the platform; and
displaying the CCM information and each set of platform-specific CCM information in an integrated display.
